(19) United States
(12) Patent Application Publication
(10) Pub. No.: US 2008/0088865 A1
(43) Pub. Date: Apr. 17, 2008

(54) Information Processing Device and Printing Setup Method

(75) Inventor: Takashi NAGAI, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/871,097

(22) Filed: Oct. 11, 2007

(30) Foreign Application Priority Data
Oct. 13, 2006 (JP) 2006-280290
Aug. 13, 2007 (JP) 2007-210941

(51) Int. Cl. G06F 15/00

(52) U.S. Cl. 358/1.13

(57) ABSTRACT

An information processing device comprising a memory unit that stores a combination of set values (hereinafter referred to as “preset data”) relating to a plurality of printing setting items, and information of printing setting items (hereinafter referred to as “temporary setting items”) for which set values can be specified temporarily for the preset data among the plurality of printing setting items in a state where the combination and the information are associated with each other.

The entire disclosure of Japanese Patent Application No. 2006-280290 filed on Oct. 13, 2006 and No. 2007-210941 filed on Aug. 13, 2007 are expressly incorporated by reference herein.

### BACKGROUND

1. Technical Field

The aspect of the present invention relates to information processing technology for carrying out printing setup of a printer device and the like, and more particularly relates to an information processing technology suitable in the case of registering a combination of preset values relating to a plurality of printing setting items and using that combination to carry out printing.

2. Related Art

Various printing setups for printing by a printer device are usually carried out using a printer driver. In recent years, printer driver printing setups have become more complex with a trend of increasing burden on a user when carrying out the settings in conjunction with the higher functionality of printer devices.

A preset type printing setup method is disclosed which is capable of easily carrying out printing setup by pre-registering a combination of set values related to a plurality of printing setting items, displaying icons corresponding to the combination, and clicking on an icon to reduce the burden on the user (refer to JP-A-2002-182871).

### SUMMARY

The set values of general printing setting items such as paper size, number of copies and the like are commonly designated when printing. In existing preset type printing setup methods such as that disclosed in JP-A-2002-182871, therefore, such general setting items are not configured by pre-registering set values associated with icons, but rather are configured by the printer driver interface so as to be specifiable as needed when printing.

On the other hand, there are situations when a user may desire to specify set values in accordance with the conditions when printing for specific printing setting items other than the previously mentioned general setting items, such as, for example, whether or not to perform duplex printing, type of binding for duplex printing (binding on the long edge or binding on the short edge), and up number of N-up printing (a function for printing a collection of a plurality of pages on a single sheet). What set value a user designates for each printing setting item when printing, or the frequency of designating a set value for each printing setting item when printing depends on the user.

In existing preset type print setup methods such as that disclosed in JP-A-2002-182871, however, set values can not be modified with regard to specific printing setting items associated with icons at the stage of selecting an icon and carrying out printing setup. A user who desires to execute printing by specifying set values of such specific setting items according to conditions at print time has to perform the extremely complex labor of modifying the set values associated with the specific setting items by editing the registered content of an icon each time. Furthermore, prior creation of a plurality of icons that are respectively associated with set values that may be specified and selecting one icon from among the plurality of icons when printing may be considered. In this case, many icons may be registered which are similar but differ only in part of the set values of the specific setting item, which is inconveniently confusing when selecting an icon, and undesirable from the perspective of icon management.

The aspect of the present invention provides a novel framework which allows flexible modification of a set value in accordance with conditions when printing for a specified printing setting item while allowing a simple printing setup by a preset method.

The information processing device of the aspect of the invention is an information processing device comprising a memory unit that stores a combination of set values (preset data) relating to a plurality of print setting items and stores information of print setting items (temporary setting items) for which set values can be specified temporarily for the preset data among the plurality of printing setting items in a state where the combination and the information are associated each other. The memory unit desirably stores preset symbol for selecting the preset data in association with the preset data and information of the temporary setting items

The information processing device further comprises a first display control unit that displays preset symbols stored in the memory unit on a display part; a first selecting unit that selects one among the preset symbols stored in the memory unit; a second display control unit that displays on a display part a menu, for which a user can specify a set value relating to a temporary setting item corresponding to the preset symbol (selected preset symbol) selected by the first selecting unit; a second selecting unit that selects a user specified set value relating to a temporary setting item corresponding to a selected preset symbol as a temporary set value; and a printing setup unit that reads the preset data corresponding to the selected preset symbol from the memory unit, substitutes a set value of the temporary setting item of the read preset data with the temporary set value selected by the second selecting unit, and carries out the printing setup based on the substituted preset data

Preferably, the second display control unit displays setting value candidates for temporary setting items, and the second selecting unit selects one among the displayed setting value candidates as the temporary set value.

According to this configuration, when preset data are selected and printing setup is carried out, printing setup is easily accomplished for a plurality of printing setting items using the preset data and printing setup can also be accomplished by flexibly modifying the set values for temporary setting items in accordance with conditions when printing because printing setup allows the set values to be modified for temporary setting items without modifying the preset data itself.

Preferably, the information processing device comprises a temporary setting item registering unit that selects a temporary setting item corresponding to the selected preset symbol selected from among a plurality of printing setting items based on user input, and stores the temporary setting item in the memory unit.

According to this configuration, printing setup is easily accomplished for a plurality of printing setting items using the preset data and printing setup can also be accomplished by flexibly modifying the set values for user-selected desirable temporary setting items in accordance with conditions when printing if the user has selected temporary setting items that match his own operating needs (for example, printing setting items that have a high frequency of set value modification) and registered preset data.

Preferably, the information processing device comprises a third display control unit that displays, on a display part, the setting value candidates for each of the plurality of printing setting items regarding the selected preset symbol, and a preset data editing unit that selects, as a set value, one among the setting value candidates displayed by the third display control unit for each of the plurality of the printing setting items, and stores the combination of selected set values in the memory unit as preset data corresponding to the selected preset symbol.

More preferably, the second selecting unit selects, as a default temporary set value, the set value which is set in the preset data corresponding to the selected preset symbol from among the displayed setting value candidates.

Even more preferably, the information processing device comprises a unit that manages, in association with the preset data, information representing the frequency with which a printing setup is carried out based on the preset data, and the display control unit determines the display position of the preset symbols based on the information on the frequency of printing setups managed by the unit.

The printing setup method of the aspect of the invention includes a step of storing, in memory, a combination of set values (preset data) relating to a plurality of printing setting items, information of printing setting items (temporary setting items) for which set values can be specified temporarily for the preset data among the plurality of printing setting items, and preset symbol for selecting the preset data in a state where the combination, the information and the preset symbol are associated one another; a first display control step of displaying the stored preset symbols on a display part; a first selecting step of selecting one among the stored preset symbols; a second display control step of displaying a menu for which a user can specify a set value relating to a temporary setting item corresponding to the preset symbol (selected preset symbol) selected in the first selecting step; a second selecting step of selecting a user specified set value related to a temporary setting item corresponding to a selected preset symbol as a temporary set value; and a printing setup step of reading the preset data corresponding to the selected preset symbol from the preset data to be managed, substituting a set value of the temporary setting item of the read preset data with the temporary set value selected by the second selection step, and carrying out the printing setup based on the substituted preset data.

The printing setup method of the aspect of the invention can be executed by an information processing device (computer), and a program for executing this method may be installed or loaded through various media such as CD-ROM, magnetic disk, semiconductor memory, and communication network and the like.

The aspect of the invention provides a novel framework which allows flexible modification of set values in accordance with conditions when printing for a specified printing set item while allowing a simple printing setup by a preset method.

### BRIEF DESCRIPTION OF THE DRAWINGS

FIG. 1 is a block diagram showing the configuration of a printer system 1 according to an embodiment of the present invention;

FIGS. 2A-2C are block diagrams showing the function configuration of a host device 10;

FIG. 3 shows an example of the data structure of a printing setup management information storage unit 301;

FIG. 4 shows an example of the data structure of a preset data storage unit 302;

FIG. 5 is a block diagram showing the function configuration of a printer device 20;

FIG. 6 is a flow chart showing the printing sequence in the printer system 1;

FIG. 7 is a flow chart showing the printing sequence in the printer system 1;

FIG. 8 is a flow chart showing the printing sequence in the printer system 1;

FIG. 9 is a flow chart showing the printing sequence in the printer system 1;

FIG. 10A and 10B show an example of the display of the preset base printing setup window 100; and

FIG. 11 shows an example of the display of the preset data editing window 200.

### DESCRIPTION OF EXEMPLARY EMBODIMENTS

### First Embodiment

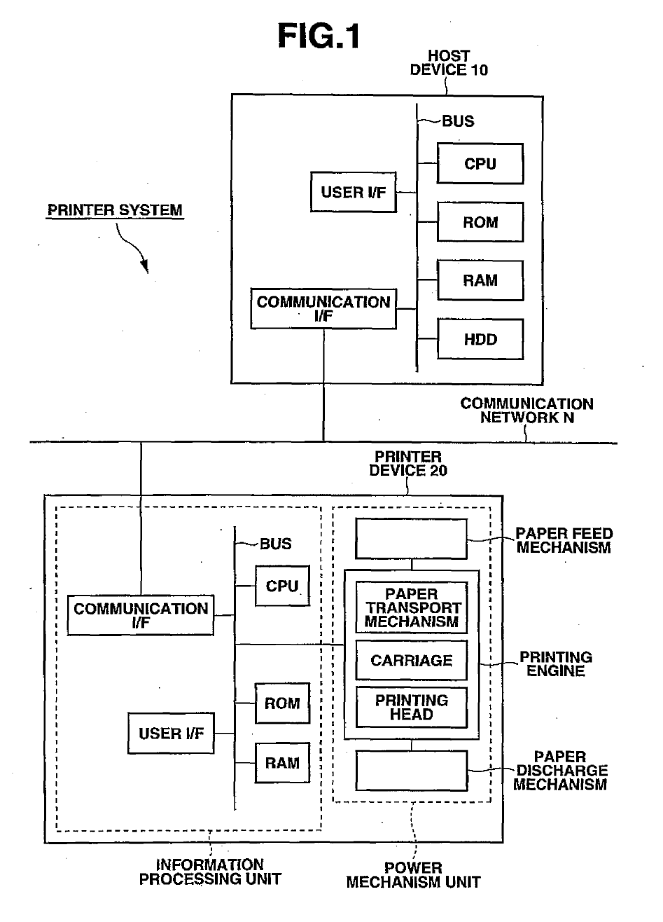

FIG. 1 is a block diagram showing the hardware structure of a printer system 1 according to an embodiment of the present invention. As shown in FIG. 1, the printer system 1 includes a host device 10, and a printer (image forming apparatus) 20 which is configured so as to be capable of communication with the host device 10 through a communication network N (LAN, internet, dedicated line, packet communication network, device connection interface such as a USB or the like, or combinations thereof; either or both wired and wireless forms can be adopted).

Host Device

The host device 10 is provided with hardware such as a CPU, ROM, RAM, user interface, communication interface, HDD and the like, and the CPU is able to access each component through a bus (refer to FIG. 1).

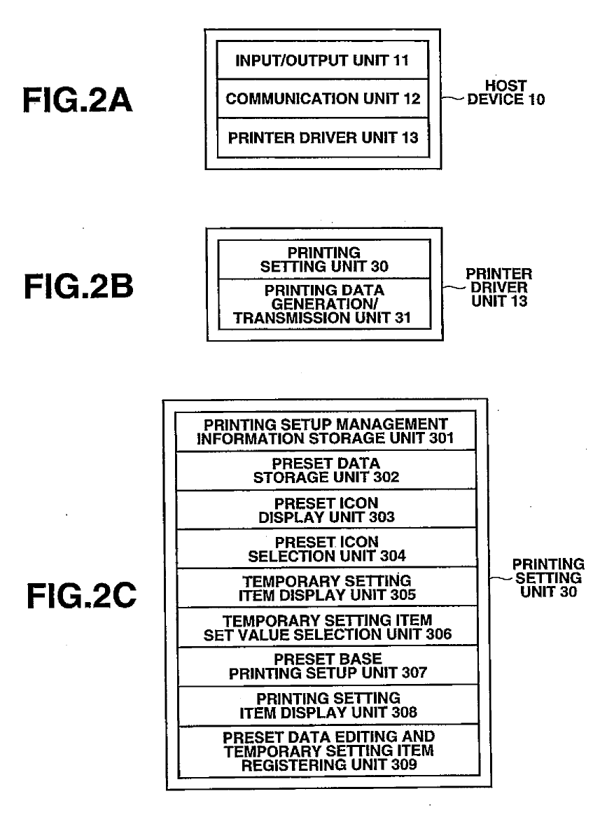

The host device 10 provides functions similar to those of an information processing device such as a normal personal computer and the like. For example, the host device 10 is provided with an input/output unit 11 for receiving various inputs from a keyboard and the like through a user interface and outputting information to a display and the like, a communication unit 12 for sending and receiving various data to and from other devices through a communication interface, and printer driver unit 13 for controlling a printer device (refer to FIG. 2A). Each of these units may be functionally realized as a result of the CPU executing a program contained in, for example, ROM, RAM or HDD within the host device 10 or an external storage medium.

The printer driver unit 13 of the host device 10 provides a functional structure similar to that of a normal printer driver. For example, the printer driver unit 13 is provided with a printing setting unit 30 for carrying out printing setup in the case of printing with the printer device 20 based on user input, and a printing data generation/transmission unit 31 for generating printing data described by a predetermined printer control language such as Postscript or the like based on the printing setup, and transmitting the data to the printer device 20 to have the printer device 20 execute printing (refer to FIG. 2B).

The printer driver unit 13 (printing setting unit 30) of the present embodiment supports a preset system capable of pre-registering a combination of preset values relating to a plurality of printing setting items as preset data, displaying an icon corresponding to the preset data, and carrying out printer setup by clicking the icon; however, the printer driver unit 13 differs from the preset system of the related art in that a set value may be temporarily specified for a specified printing setting item that have been determined to relate to the preset data among a plurality of printing setting items when preset data are selected to carry out the printing setup.

In order to execute such a printing setup function by the preset system, the printer driver unit 13 (printing setting unit 30) is provided with a printing setup management information storage unit 301, a preset data storage unit 302, a preset icon display unit 303, a preset icon selection unit 304, a temporary setting item display unit 305, a temporary setting item set value selection unit 306, a preset base printing setup unit 307, a printing setting item display unit 308, and a preset data editing and temporary setting item registering unit 309 and the like (see FIG. 2C)

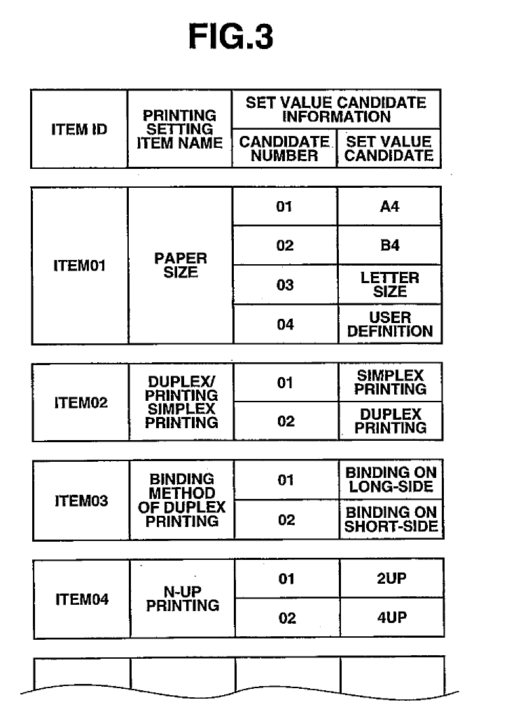

The printing setup management information storage unit 301 stores information on specifiable values (setting value candidates) as set values for each of the plurality of printing setting items which are preset objects (refer to FIG. 3).

Examples of printing setting items include, for example, paper type, number of copies, paper size, printing resolution, specification of duplex or simplex printing, binding method of duplex printing, up number of N-up printing and the like, and various setting items are possible according to the design. As shown in FIG. 3, the printing setting items are managed by assigning item IDs to printing setting items and assigning candidate numbers to setting value candidates in the present embodiment, thus providing a configuration that enables the set value of each printing setting item to be specified by designating a item ID and candidate number.

“User definition” regarding which user can define set value can be stored as setting value candidate, for some or all of the printing setting items, in addition to or in place of a setting value candidate for which the set value is defined previously. In the example shown in FIG. 3, for the printing setting item of paper size, a setting value candidate “user definition” (candidate number 04) regarding which user can define set value, in addition to the setting value candidates “A4”, “B4” and. “letter size” (candidate numbers 01 through 03) which are defined previously, are stored in a state where they are associated each other.

The preset data storage unit 302 stores a combination of set values (preset data) relating to a plurality of printing setting items, and information of printing setting items (temporary setting items), for which set values can be specified temporarily for the preset data among the plurality of printing setting items in a state where the combination and the information are associated each other.

When the preset data include printing setting items for which “user definition” is selected as a set value, these printing setting items can be automatically made temporary setting items.

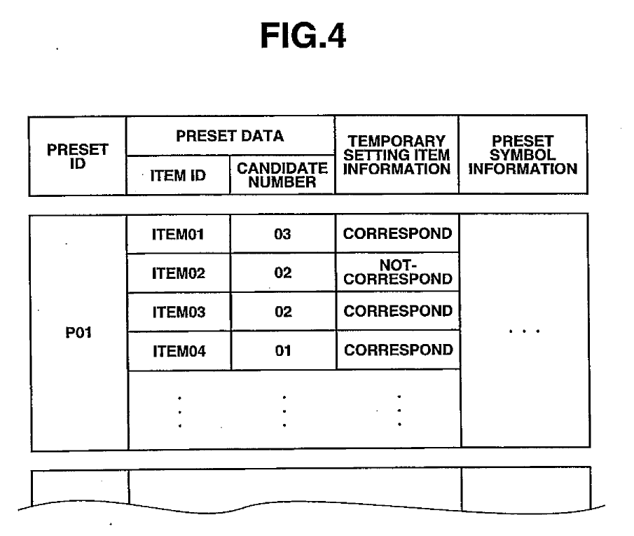

The preset data storage unit 302 further stores preset symbol information for selecting the preset data which are stored in association with the preset data and information of the temporary setting items (refer to FIG. 4).

Specifying a temporary set value means a volatile specification for which the specification content will be cleared when a power source is turned off, when the printer driver process ends, or when the set value is modified such as when other preset data are selected.

In the example shown in FIG. 4, the information relating to the temporary setting items is stored as information as to whether or not each printing setting item corresponds to the temporary setting item. Furthermore, the preset symbol information may include, for example, icon image information, preset data name and the like.

The other units 303 through 309 are described in the description of the printing operation which follows later.

Printer Device

The printer device 20 has the same structure as a normal printer (refer to FIG. 1).

For example, the printer device 20 is provided with a power mechanism unit configured by, for example, a paper feed mechanism that feeds paper to the printer device, a printing engine that carries out printing, and a paper discharge mechanism that discharges paper from the printer device. The printing engine is normally configured by a paper transport mechanism, carriage mechanism, printing head and the like, and various types of printing engines can be used which correspond to, for example, a serial printer, which prints in single character units in the manner of an ink jet printer or thermal transfer printer, a line printer, which prints in single line units, or a page printer, which prints in page units.

In addition, the printer device 20 is provided with, for example, an information processing unit comprising a CPU, ROM, RAM, communication interface and console panel or other user interface and the like. The CPU of the printer device 20 is configured so as to be capable of accessing each component through a bus, and for example, controlling the power mechanism unit to actually carry out a printing operation based on printing data sent via the communication interface.

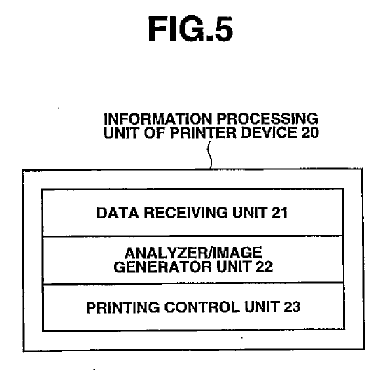

The function of the information processing unit of the printer device 20 is similar to the function of the information processing unit of existing printer devices in principle. For example, the information processing unit of printer device 20 is provided with a data receiving unit 21 that receives print data from the host device, an analyzer/image generator unit 22 that analyzes print data, generates one band or one page of a printing image in a raster format, and then stores that printing image in an image buffer, and a printing control unit 23 that transfers a predetermined unit (such as one pass) of a printing image from the image buffer to the printing engine, and executes printing while controlling the printing engine (refer to FIG. 5). Furthermore, each unit is functionally realized as a result of the CPU executing a program contained in, for example, ROM or RAM within the printer device 20 or an external storage medium.

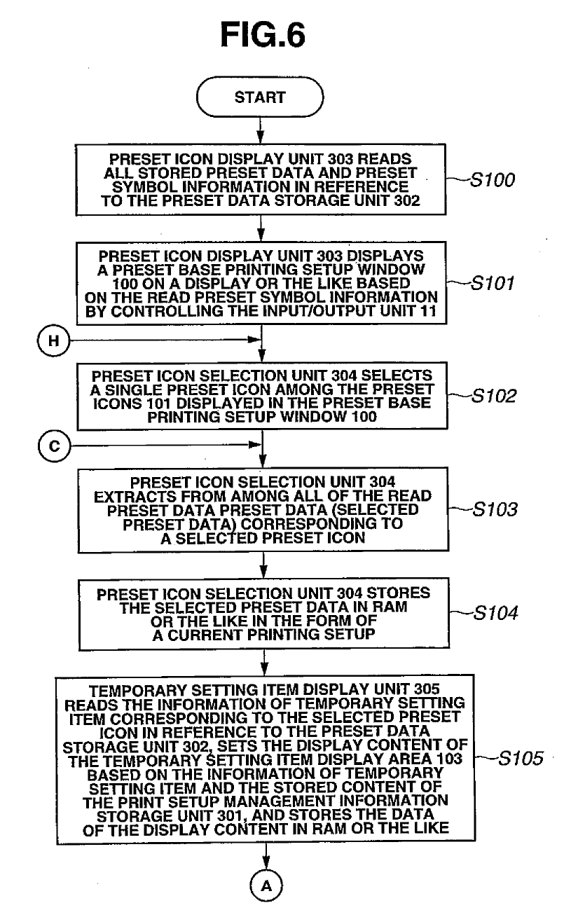

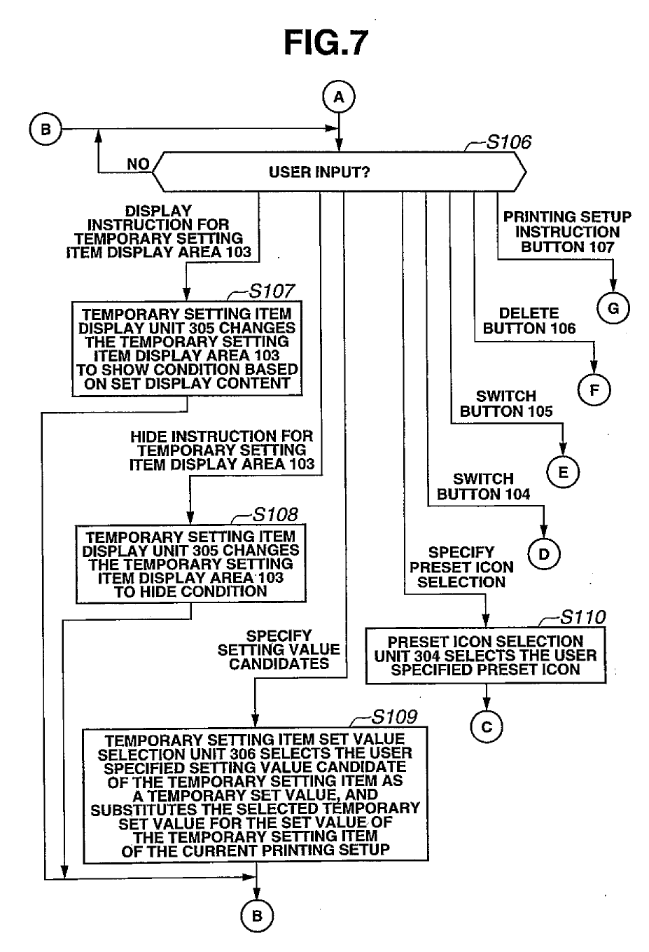

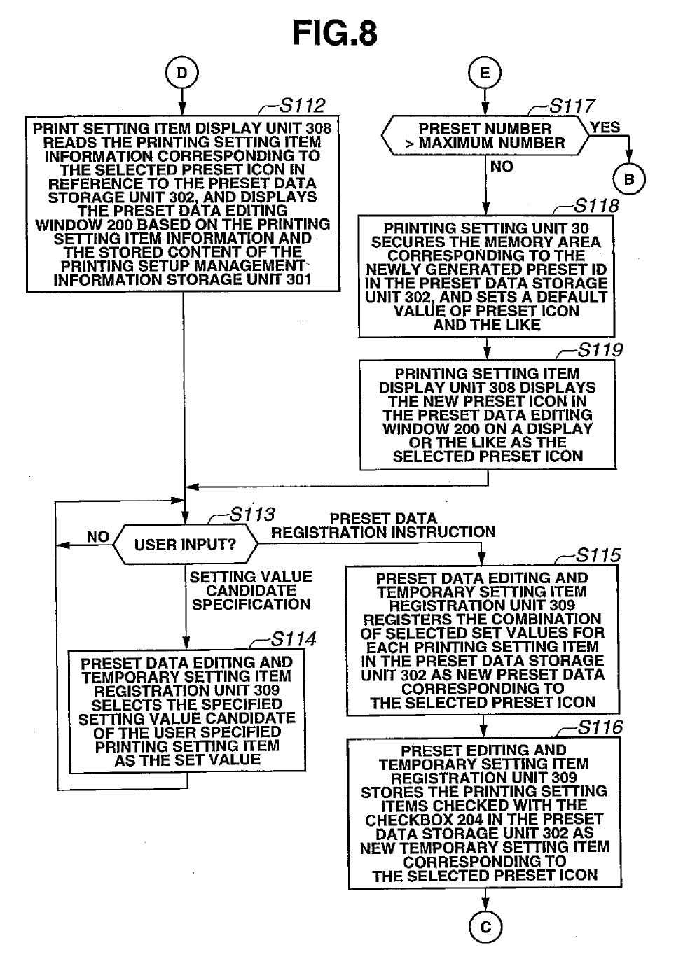

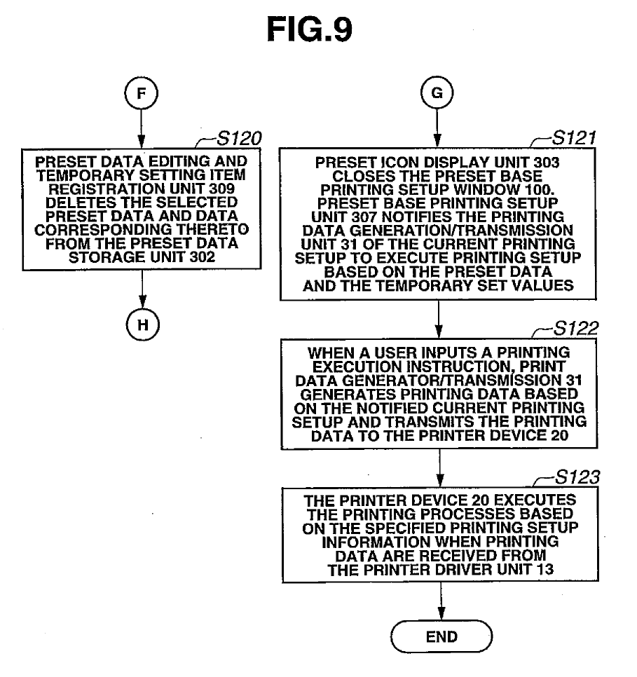

The printing sequence in the printer system 1 is described below with reference to the flow charts in FIGS. 6 through 9. Furthermore, each step (including partial steps not indicated with reference symbols) can be executed while arbitrarily changing the order thereof or can be executed in parallel provided there is no contradiction with the contents of processing.

Printing Sequence

The printer driver unit 13 of the host device 10 executes the following processing when a printing setup request is received from a printer property setting menu or an application program running externally or on host device 10 or the like.

The preset icon display unit 303 first reads all preset data and preset symbol information stored in memory in reference to the preset data storage unit 302 (S100).

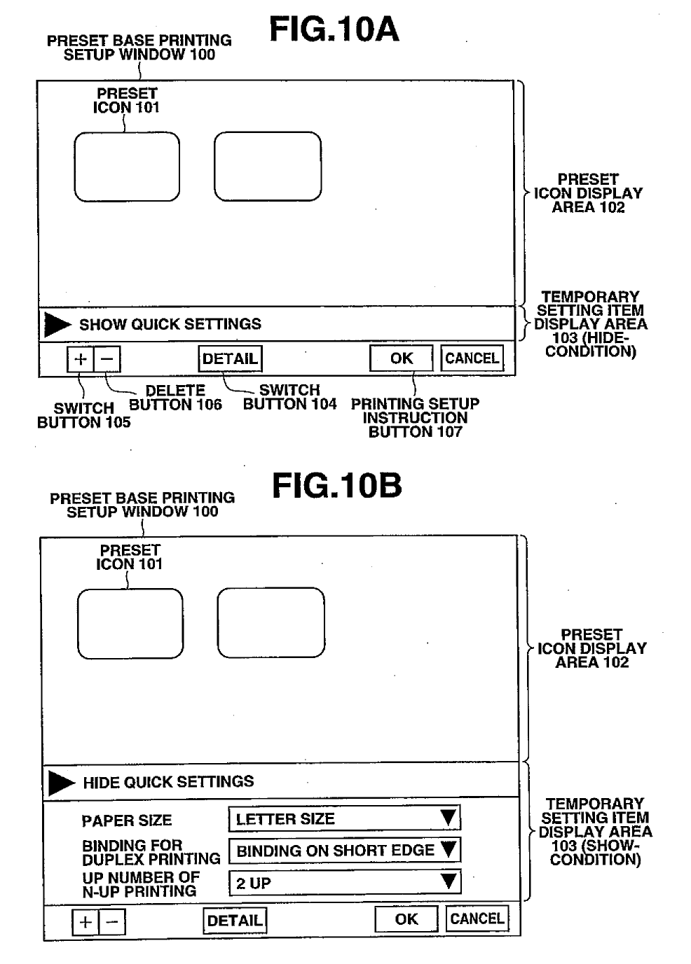

Next, the preset icon display unit 303 displays a preset base printing setup window 100 on a display or the like based on the read preset symbol information by controlling the input/output unit 11 (S101) (refer to FIGS. 10A and 10B).

As shown in FIGS. 10A and 10B, the preset base printing setup window 100 is configured so as to contain, for example, a preset icon display area 102, in which are arranged and displayed icon and preset data name sets 101 contained in the read preset symbol information (hereinafter collectively referred to as “preset icons”), a temporary setting item display area 103 for displaying information relating to temporary setting items, switch buttons 104 and 105 for switching to editing windows for existing preset data and new preset data, a delete button 106 for deleting existing preset data, and a printing setup instruction button 107.

Furthermore, a scroll bar and the like may be displayed in cases of a large number of preset icons prevent all of the preset icons from being simultaneously displayed in the preset icon display area 102. Furthermore, at this stage the temporary setting item display area 103 may temporarily hide its display content (hide-condition) (refer to FIG. 10A).

Next, the preset icon selection unit 304 selects a single preset icon 101 among the preset icons 101 displayed in the preset base printing setup window 100 (S102). Although selection criteria can be determined according to the design, criteria may be employed, such as selecting preset icons with high utilization frequency or selecting preset icons selected during a previous execution of printing setup.

Next, the preset icon selection unit 304 extracts, from among all of the read preset data, preset data (hereinafter referred to as “selected preset data”) corresponding to the selected preset icon (S103), and then stores the selected preset data in RAM or the like in the form of a current printing setup (S104).

Then, the temporary setting item display unit 305 reads the information of the temporary setting item corresponding to the selected preset icon in reference to the preset data storage unit 302, sets the display content of the temporary setting item display area 103 based on the information of the temporary setting item and the stored content of the printing setup management information storage unit 301, and stores the data of the display content in RAM or the like (S105). Specifically, for each temporary setting item, a temporary setting item name, a menu for which a user can specify set value, or the like are set to the temporary setting item display area 103. The menu for which a user can specify set value also contains a menu for specifying setting value candidates for which set values are defined previously (for example, a pull-down menu), a menu for which a user can define (input) set values and the like.

Selection, as a default temporary set value, of a set value, which is set in the selected preset data among the setting value candidates, is desirable for pull-down menus or the like.

Next, the printing setting unit 30 waits for an input from a user (S106).

(1) When a user inputs a display instruction for the temporary setting item display area 103 while the temporary setting item display area 103 is in hide-condition (for example, when the “Show Quick Setting” of FIG. 10A is clicked), the temporary setting item display unit 305 changes the temporary setting item display area 103 to show based on the set display content (show-condition) (S107), and then the program returns to S106.

When changing the temporary setting item display area 103 to show-condition, the temporary setting item display unit 305 modifies the size of the temporary setting item display area 103 in accordance with the number of temporary setting items and displays all the temporary setting item names in the preset base printing setup window 100. When there are numerous temporary setting items and all of the temporary setting items can not be displayed, a scrollbar or the like may be displayed in the temporary setting item display area 103.

Specifiable setting value candidates for each of the temporary setting items are displayed in the temporary setting item display area 103 in show-condition (refer to FIG. 10B). In this case, display of specifiable setting value candidates signifies a mode where setting value candidates are always displayed or a mode in which options are displayed for specification for a case where a user desires to display a menu such as, for example, a pull-down menu.

A user can easily set temporary setting items in use of the temporary setting item display area 103, in a manner which is described later, displaying collectively the temporary setting item name and a menu for which a user can specify a set value or the like, for each temporary setting item when the temporary setting item display area 103 is in show-condition.

(2) When a user inputs a hide instruction for the temporary setting item display area 103 while the temporary setting item display area 103 is in show-condition (for example, when the “Hide Quick Setting” of FIG. 10B is clicked), the temporary setting item display unit 305 changes the temporary setting item display area 103 to hide (S108), and then the program returns to S106.

(3) When a user has specified a setting value candidate of a predetermined temporary setting item using, for example, a pull-down menu, while the temporary setting item display area 103 is in show-condition, the temporary setting item set value selection unit 306 selects the specified setting value candidate of the temporary setting item as a temporary set value, and substitutes the selected temporary set value for the set value of the temporary setting item of the current printing setup stored in RAM or the like (S109), then the program returns to S106.

Furthermore, when the user specified setting value candidate is “user definition”, the temporary setting item set value selection unit 306 receives user defined set value of the temporary setting item from the user using a menu for user defined (input) set values, and the defined set value received from the user is substituted for the set value of the temporary setting item of the current printing setup stored in RAM or the like.

Furthermore, it can be configured so as to store the received user defined set value, assigning a new candidate number to it, in the printing setup management information storage unit 301 and, thereafter, display the received user defined set value as a setting value candidate defined previously in the pull-down menu or the like.

At this time, a configuration is desirable in which a check is made as to whether or not there is a conflict between the selected temporary set value and the set values of the other printing setting items of the current printing setup (including the temporary setting items), and when a conflict exists, an indicator alarm alerts the user, or a set value that nullifies the conflict is automatically selected. A conflict may occur, for example, when thick paper is specified as a paper type and duplex printing is specified even though duplex printing cannot be executed in use of thick paper.

(4) When a preset icon selection instruction from a user is received (for example, when the user clicks a mouse or the like on a preset icon displayed in the preset icon display area 102), the preset icon selection unit 304 selects the user selected preset icon (S110), and the program returns to S103. In this case, the temporary setting item display area 103 is generally hidden.

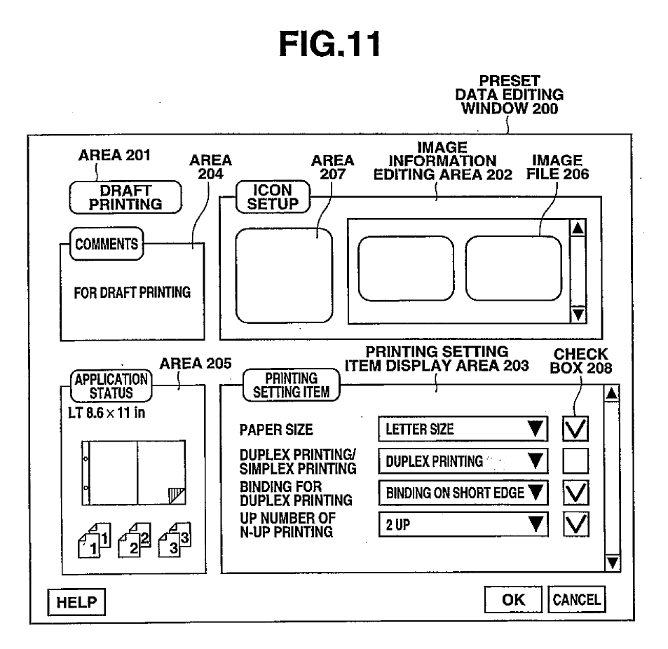

(5) When a user has pressed the switch button 104 for switching to the editing window of the existing preset data, the printing setting item display unit 308 reads the print setting item information corresponding to the selected preset icon in reference to the preset data storage unit 302, and displays the preset data editing window 200 on a display or the like based on the print setting item information and the stored content of the printing setup management information storage unit 301 (S112) (refer to FIG. 11).

As shown in FIG. 11, the preset data editing window 200 is configured so as to include an area 201 for displaying the names of the selected preset data, an area 202 for editing the image information of the selected preset icon, a print setting item display area 203, an area 204 for displaying comments related to the selected preset data, an area 205 for schematically showing the application status when printing is carried out using the selected set values.

The icon image editing area 202 is configured, for example, so as to allow an icon image to be set by dragging and dropping an optional image file 206 in a setting area 207. Furthermore, although the printing setting item display area 203 is configured to include printing setting item names and pull-down menus for which setting value candidates can be specified for each printing setting items similar to the temporary setting item display area 103, the display area 203 also includes a check box 208 for each printing setting item that is checked when specified as a temporary setting item.

As described above, according to the present embodiment, in the case where there is a printing setting item, for which “user definition” is selected as a set value, this printing setting item is a temporary setting item, hence the printing setting item display unit 308 displays, as a temporary setting item, each printing setting item for which “user defined” is specified as a setting value candidate in the print setting item display area 203 while automatically checking is performed with a check box 208.

In the case of a pull-down menus or the like, it is desirable to pre-select a set value included in the selected preset data among the setting value candidates as a default value. Furthermore, it is desirable to pre-check the check box 208 beforehand for the temporary setting items corresponding to the selected preset data.

Next, the printing setting unit 30 waits for an input from a user (S113).

When a setting value candidate has been specified by the user for a printing setting item, the preset data editing and temporary setting item registering unit 309 selects the specified setting value candidate as the set value of the printing setting item (S114), then the program returns to S113.

When a user has input a preset data registering instruction, the preset data editing and temporary setting item registering unit 309 records the combination of selected set values (and default values for printing setting items not specified by the user) of each printing setting item as new preset data corresponding to the selected preset icon in the preset data storage unit 302 (S115). Furthermore, the printing setting items checked with checkboxes 208 are stored (registered) in the preset data storage unit 302 as new temporary setting items corresponding to the selected preset icon (S116). After the preset data editing window 200 has closed, the program returns to S103.

It is desirable that a configuration is employed in which a check is made as to whether or not any conflicts exist among the selected set values of each printing setting item, and when a conflict does exist, a registering instruction input can not be received from the user by, for example, displaying the registering instruction input button by gray-out display.

(6) When a user has pressed the switch button 105 to switch to the editing window of the new preset data, the printing setting unit 30 checks whether the number of preset data has exceeded a preset maximum number (S117), and when the maximum number is exceeded, the printing setting unit 30 displays, for example, a predetermined error message, and the program returns to S106.

When the maximum number is not exceeded, the printing setting unit 30 secures the memory area corresponding to the newly generated preset ID in the preset data storage unit 302, and sets the default value of the preset icon and the like (S118). The printing setting item display unit 308 displays the new preset data icon as the selected preset data icon in the preset data editing window 200 on a display or the like (S119), and the program continues to S113.

(7) When a user has pressed the delete button 106 for deleting the existing preset data, the preset data editing and temporary setting item registering unit 309 deletes the selected preset data and other data corresponding thereto from the preset data storage unit 302 (S120), and the program returns to S102.

(8) When a user has pressed the printing setup instruction button 107, the preset icon display unit 303 closes the preset base printing setup window 100. The preset base printing setup unit 307 notifies the printing data generation/transmission unit 31 of the current printing setup stored in RAM or the like to execute a printing setup based on the preset data and the temporary set values (S121).

When the printing setup is executed and a print execution instruction is input by a user, the printing data generation/transmission unit 31 generates printing data based on the notified current printing setup, and transmits the printing data to the printer device 20 (S122). The printing data are configured so as to include the specified printing setup information, and the data of the printing object described in a printer control language similar to the existing art. When the user has input a printing instruction without executing a printing setup, the printing data may be generated by deciding that a default values of printing setting items is specified.

When printing data are received from the printer driver unit 13, the printer device 20 executes the printing process based on the specified printing setup information (S123). For example, printing data are analyzed, and then one band or one page of the raster format printing image in accordance with the specifications for printing resolution and the up number of N-up printing and the like is generated to be stored in an image buffer In addition, a predetermined unit (such as one pass) of the printing image, for example, is transferred from the image buffer to the printing engine based on a control command contained in the printing data, then the power mechanism unit is controlled so that printing is executed in a mode corresponding to specifications such as the type of paper, number of printouts, paper size, designation of duplex or simplex printing and binding method of duplex printing.

Thus, according to the present embodiment, the configuration is such that, while employing a framework for executing a printing setup for a plurality of printing setting items by selecting pre-registered preset data, information of printing setting items (temporary setting items) which allow set values to be temporarily specified for the preset data among the plurality of printing setting items for each preset data is stored in association, whereby the set values for temporary setting items when carrying out printing setup by selecting the preset data can be specified.

According to this configuration, printing setup is easily accomplished for a plurality of printing setting items using the preset data and printing setup can also be accomplished by flexibly modifying the set values for temporary setting items in accordance with conditions when printing, if the user registers the preset data by selecting, as temporary setting items, printing setting items that match his own operating needs (for example, printing setting items that have a high frequency of set value modification) since printing setup can be carried out by modifying the set values of temporary setting item without modifying the preset data themselves.

According to the present embodiment, a user can concisely and easily set temporary setting items using the temporary setting item display area 103 since the information required for setting temporary setting items (temporary setting item name, menu for which a user can specify set values and the like) is displayed collectively in the temporary setting item display area 103 provided in the preset base printing setup window 100.

Modifications

The present invention is not limited to the above embodiment, and may be variously modified for applications.

For example, when preset icons are displayed in the preset icon display area 102, the preset icons may be rearranged in order of usage frequency and displayed to allow efficient selection by the user.

Specifically, the printing setting unit 30 is provided with a unit that manages, in association with the preset data, information (usage frequency information), of the frequency, with which a printing setup is carried out based on the preset data. The preset data storage unit 302 may also be configured to store frequency information in association with a preset ID. Then, the preset icon display unit 303 determines the preset icon display position such as, for example, arranged from left to right in a sequence of increasing frequency based on the frequency information. Moreover, the frequency information may also be used when the preset icon selection unit 304 selects a preset icon based on usage frequency in S102.

For example, a user may modify the order in which the temporary setting items are displayed in the temporary setting item display area 103. In this case, a menu is provided for modifying the layout sequence of the printing setting items in the printing setting item display area 203 of the preset data editing window 200, and layout sequence information is stored together in the preset data storage unit 302 in S115 and S116 after a layout sequence specification is received simultaneously with the reception of a setting value candidate specification from the user in S114. Temporary setting items may be arranged by the stored layout sequence (user specified layout sequence) when the display content of the temporary setting item display area 103 is set in S105.

For example, although the printer device 20 is configured to execute processing for printer data interpretation, print image generation and the like in the present embodiment, the host device 10 (printer driver unit 13) may also execute all or part of these processes.

What is claimed is:

1. An information processing device comprising a memory unit that stores a combination of set values (hereinafter referred to as “Preset data”) relating to a plurality of printing setting items, and information of printing setting items (hereinafter referred to as “temporary setting items”) for which set values can be specified temporarily for the preset data among the plurality of printing setting items in a state where the combination and the information are associated with each other.

2. The information processing device according to claim 1, wherein the memory unit stores preset symbol for selecting the preset data in association with the preset data and information of the temporary setting items.

3. The information processing device according to claim 2 further comprising:
a first display control unit that displays preset symbols stored in the memory unit on a display part;
a first selecting unit that selects one among the preset symbols stored in the memory unit;
a second display control unit that displays on a display part a menu, for which a user can specify a set value relating to a temporary setting item corresponding to the preset symbol selected by the first selecting unit (hereinafter referred to as a “selected preset symbol”);
a second selecting unit that selects a user specified set value relating to a temporary setting item corresponding to a selected preset symbol as a temporary set value; and
a printing setup unit that reads the preset data corresponding to the selected preset symbol from the memory unit, substitutes a set value of the temporary setting item of the read preset data with the temporary set value selected by the second selecting unit, and carries out the printing setup based on the substituted preset data.

4. The information processing device according to claim 3, wherein the second display control unit displays setting value candidates for temporary setting items on the display part, and the second selecting unit selects one among the displayed setting value candidates as the temporary set value.

5. The information processing device according to claim 3, comprising a temporary setting item registering unit that selects a temporary setting item corresponding to the selected preset symbol selected from a plurality of printing setting items based on user input, and stores the temporary setting item in the memory unit.

6. The information processing device according to claim 3, comprising:
a third display control unit that displays, on a display part, setting value candidates for each of a plurality of printing setting items regarding selected preset symbol; and
a preset data editing unit that selects, as a set value, one among the setting value candidates displayed by the third display control unit for each of the plurality of printing setting items, and stores the combination of selected set values in the memory unit as preset data corresponding to the selected preset symbol.

7. The information processing device according to claim 3, wherein the second selecting unit selects, as a default temporary set value, the set value which is set in the preset data corresponding to the selected preset symbol from among the displayed setting value candidates.

8. The information processing device according to claim 3, comprising a unit that manages, in association with the preset data, information of a frequency with which a printing setup is carried out based on the preset data,
wherein the display control unit determines a display position of the preset symbols based on the information on the frequency of printing setups managed by the unit.

9. A printing setup method comprising:
a step of storing in memory a combination of set values related to a plurality of printing setting items (hereinafter referred to as “preset data”), information of printing setting items (hereinafter referred to as “temporary setting items”) for which set values can be specified temporarily for the preset data among the plurality of printing setting items, and preset symbol for selecting the preset data in a state where the combination, the information, and the preset symbol are associated with one another;
a first display control step of displaying the stored preset symbols on a display part;
a first selecting step of selecting one among the stored preset symbols;
a second display control step of displaying a menu for which a user can specify a set value relating to a temporary setting item corresponding to the preset symbol selected in the first selecting step (hereinafter referred to as a “selected preset symbol”);
a second selecting step of selecting a user specified set value related to a temporary setting item corresponding to a selected preset symbol as a temporary set value; and
a printing setup step of reading the preset data corresponding to the selected preset symbol from the preset data to be managed, substituting a set value of the temporary setting item of the read preset data with the temporary set value selected by the second selection step, and carrying out the printing setup based on the substituted preset data.

10. A program for executing the printing setup method of claim 9 on a computer.
